(19) United States
(12) Patent Application Publication
(10) Pub. No.: US 2004/0168777 A1
(43) Pub. Date: Sep. 2, 2004

(54) Pinchless multi-panel door

(76) Inventor: Robert A. Kelley, Anaheim, CA (US)

Correspondence Address: MICHAEL A. SHIPPEY, PH. D., 4848 LAKEVIEW AVENUE, SUITE B, YORBA LINDA, CA, 92886, US

(21) Appl. No.: 10/377,209

(22) Filed: Feb. 28, 2003

(51) Int. Cl. E06B 9/00

(52) U.S. Cl. 160/229.1

(57) ABSTRACT

This invention pertains to a multi-panel or sectional door having a specially designed edge profile that coordinates between the panels in such a way as to prevent any items from being pinched between the door sections while the panels are moving. The door additionally contains exterior trim pieces that are designed to open and close cooperatively with the door sections, and avoid any gaps forming during operation. Finally, the door may contain optional side shields to the trim pieces, said shields designed to avoid side gaps between the trim and the door during operation.

### REFERENCES CITED

U.S. Patent Documents cited

| | | |
|---|---|---|
| U.S. Pat. No. 6,408486 | Inventor Saliba | Jun. 25, 2002 |
| U.S. Pat. No. 6,328,091 | Inventor Whitley | Dec. 11, 2001 |
| U.S. Pat. No. 6,076,590 | Inventor Ford | Jun. 20, 2000 |
| U.S. Pat. No. 6,006,817 | Inventor Stone | Dec. 28, 1999 |
| U.S. Pat. No. 5,782,283 | Inventor Kendall | Jul. 21, 1998 |
| U.S. Pat. No. 5,709,259 | Inventor Lewis | Jan. 20, 1998 |
| U.S. Pat. No. 3,941,180 | Inventor Thill | Mar. 2, 1976 |

### BACKGROUND OF THE INVENTION

1. Field of the Invention

The present invention relates to a multi-panel or sectional door in which the edge of each panel is formed in such a way as to be interlocking, and move conformably so as to minimize gaps formed during movement, and thus prevent any items from being pinched between the door panels while the entire door is being raised or lowered on a wheel track assembly.

2. Description of Related Art

Multi-panel or sectional doors have been commonly used for many years as closures for large openings in homes and commercial buildings, such as for garages, storage units, warehouse loading bays, truck and transport containers, and the like. As the name implies, multi-panel or sectional doors are comprised of many sections joined together. Such doors are a significant improvement over single piece doors for many reasons, including ease of manufacturing smaller panels, transporting smaller panels to the site, building and installing a door in sections, and operating a door on a track using a small pulley or other assembly instead of relying on huge spring and hinge assemblies to lift a single heavy piece, which also requires a larger volume of space for operation than a sectional door on a track. For all these reasons, a multi-panel or sectional door is a more efficient means for covering a large opening—and in fact, with the invention of this type of door, it has been possible to build units with larger openings than could previously be covered by a single piece door.

The separate panels of sectional doors are usually connected together with hinges or other assemblies so that the panels can move in angles to each other to allow the door to be raised or lowered on a curved track, and therein lies a primary disadvantage to an otherwise highly useful invention. While in motion, the separate panels can squeeze and pinch objects in the gaps between the panels, thus catching unwary fingers, clothing, and other foreign objects, resulting in injury or property loss, and possibly damage to the door itself.

Much prior art has tried to resolve the sectional door pinch problem. U.S. Pat. Nos. 6,408,486, 6,328,091, 6,0006,817, 5,782,283, 5,709,259, 3,941,180 all show panel edges adapted for hinge assemblies that are integrated into the door in troughs, channels, indentations, or specially designed insets or curves and that require specialized bracket and hinge assemblies intended to minimize the pinching action of the panels when moving.

However, the prior art has not eliminated the pinch problem, and in fact has proposed solutions that are relatively expensive, complex, and difficult to manufacture and assemble the door panels. During installation, such panels must be exactly aligned and vibration of the moving door over time can cause misalignment, resulting in increasing interference and binding between the moving door panels, eventually leading to damage of the panels and making repair or replacement necessary. In addition, the solutions proposed thus far tend to have intricate mechanisms that are harder to maintain over time and have a greater failure rate in operating heavy doors. The simplicity of door panel edges and of the hinge and connecting mechanism is therefore of utmost importance.

### BRIEF SUMMARY OF THE INVENTION

The present invention constitutes an improvement to sectional upward or overhead moving doors. Said invention is a panel door with a specially designed edge profile that cooperates with the adjacent panel and limits the clearance between adjacent door panels, thus minimizing the possibility of pinching or catching any objects in the gap between the panels during motion. No hinge or connecting mechanism is incorporated into the edge profile of the door panel. In addition, only the edges of the door panels are specially formed so that the rest of the panel on the inside and outside of the door remains flat for easy attachment of various hinge and connecting assemblies.

The door panels can be constructed of metal, plastic, or wood, and can include insulated or non-insulated panels of varying thickness. Plastics of rigid, hard consistency, such as ABS polymers, are a popular choice of material. Various hinge and connecting assemblies can be used in holding the panels together, allowing for selection of assemblies that are most suited to the use, weight, and size of the door panels and the overall door.

The invention further contemplates trim on the surface of the door. Said trim is also specially designed to coordinate with the joint between the door panels, in such a manner as to limit clearance and avoid pinching or catching foreign objects.

Major advantages to the design of this invention is that manufacturing is more cost and time efficient, assembly and alignment is easier, and operation of the door is more reliable and durable.

### BRIEF DESCRIPTION OF THE DRAWINGS

FIG. 1 depicts a sectional door as contemplated in this invention from a rear view (e.g, from the inside of a garage or other unit).

FIG. 2 shows a cutaway side view of the present invention, in a closed position. The left layer is the exterior trim piece on the outside of the door.

FIG. 3 demonstrates a magnified segment of the interface between panels of door and associated trim. This illustrates, again from a cutaway side view, the curvature and relative positions of the trim and door sectional interfaces when the door is closed.

FIG. 3A demonstrates the same magnified segment of the interface between panels of door and associated trim as in FIG. 3. This illustrates relative positions of the trim and door sectional interfaces when the door is opening.

FIG. 4 shows a typical exterior appearance of the door.

FIG. 5 shows the detail of the interface between panels from a view from the interior of the garage. The closely fitting interface can be seen.

### DETAILED DESCRIPTION OF THE DRAWINGS

The drawing figures illustrate the preferred embodiments of this invention. The drawings may not necessarily be to scale, and certain features of the invention may be shown in generalized form in the interest of clarity and conciseness.

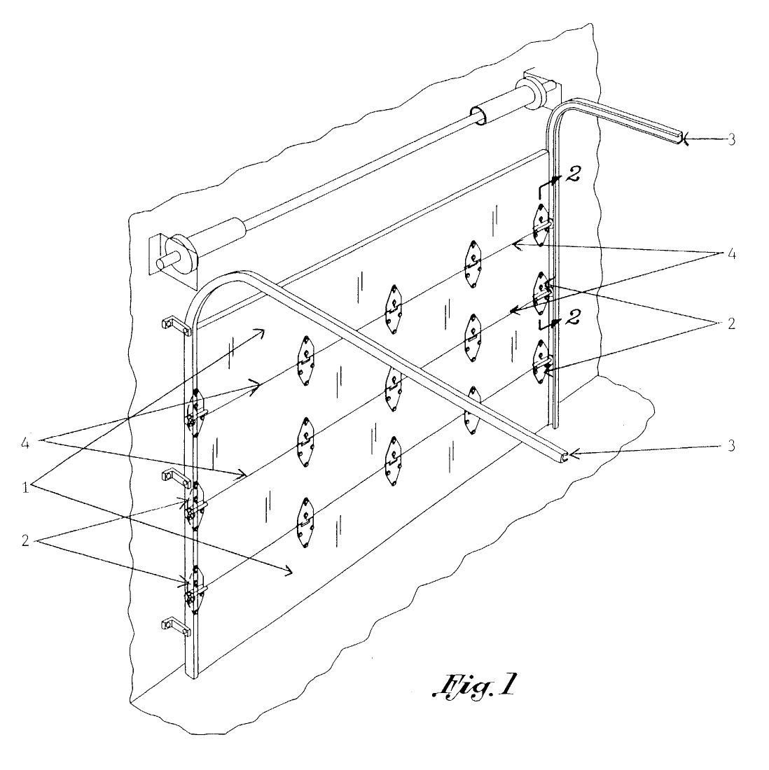

FIG. 1 shows a preferred embodiment of this invention as illustrated in a sectional door that is closed over the opening of a garage, storage shed, loading bay, or other such unit. The door is seen from a rear view, that is, from the inside of the unit. The door is opened and closed by moving it vertically. As it opens, the door panels 1 move on small wheels 2 engaged in curved guide tracks 3 at the left and right sides of the door. The door curves and moves into an overhead position below or at the ceiling level of the unit, for example like a multi-panel garage door. In closing, the door is pulled forward to curve along the guide tracks from its overhead position into a vertical position as it is lowered to close the unit's opening. The guide tracks, motion mechanism, brackets, and hinges can be any of various assemblies available depending on use, weight, material, and other variable factors dependent on the type of structure being secured by the door.

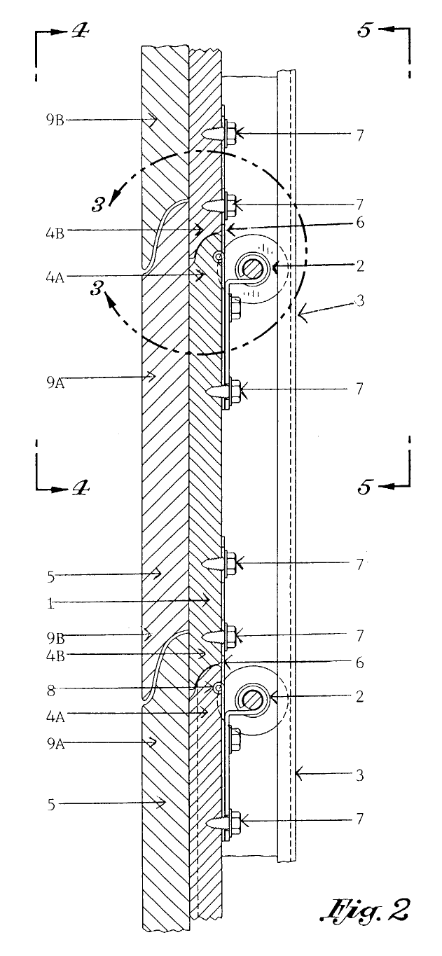

The door comprises a plurality of interconnected planar panels or sections 1. The panels are substantially planar on the rear and front faces of the door. The panel edges 4 cannot readily be seen when the door is in a closed or fully opened position. In either of these positions, the gap between the edges is so small that no foreign object can become easily lodged or inserted between the panels. Motion of the door will not change the width of this gap substantially, even when the panels are curving along the guide tracks to an overhead position because of the specially designed edge profile shown in FIG. 2, and therefore the sectional door is pinchless when in motion. Moreover, provided that the hinge and connectional assemblies used for the panels hold them in a close adjacent position, the assemblies actually used can vary without affecting the action of the door in maintaining a pinchless space between panels.

The side cutaway view in FIG. 2 shows one door panel 1 placed adjacent to the door panels above and below it, which are only partially visible here. The door panel is the central most layer in this Figure, with an optional layer of door trim 5 to the left and an illustrative guide track 3 and hinge assembly 6 to the right. For ease of reference, this cutaway view is shown as the door panel appears at its right or left-most edge where it will connect to the guide track. Trim and hardware for moving and holding the door together is placed at intervals along a door panel, and therefore the presence of all three layers will vary along any single door panel.

In FIG. 2, it can be seen that the visible portion of the door panel is planar and the hinge assembly is attached via screws 7 onto this planar surface spanning the edges of the two adjacent panels so as to connect them closely together. The hinge assembly is not inserted into the gap between the door panels at all.

The specially designed edge profile of the door panel can be seen in FIG. 2. The curving profile has been specially engineered to keep the gap between the two doors at substantially the same width while the door is in motion and while the panels are at an angle to each other, such that the gap does not become wide enough to create a pinching hazard. The curving profile of the trim is designed to operate in the same fashion, but the shape has been altered to account for the wider angle on movement necessary on the this outer layer.

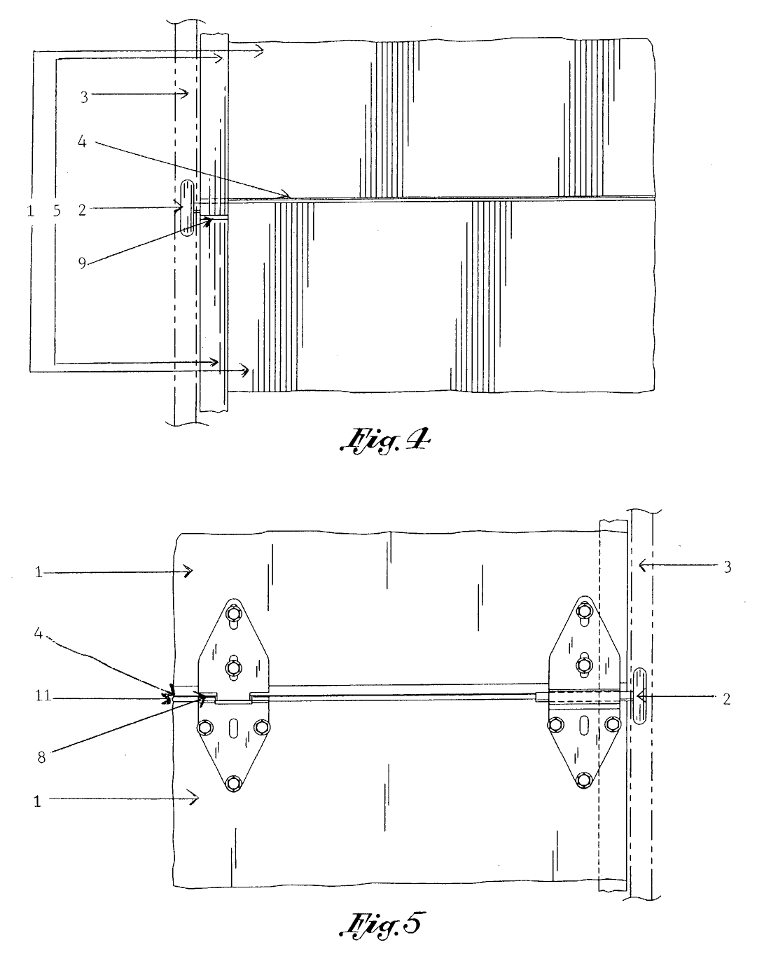

The hinge assembly that is illustrated in FIG. 2 has a circular rotating pin joint 8 of a diameter approximately 0.75 inch in size. This pin joint 8 is inset into a squared groove 11 that is cut into the entire length of the panel to accommodate three to five such hinges. This arrangement, however, is a preferred embodiment and is only illustrative of one type of hinge that may be used. Note that squared groove 11 is best viewed in FIG. 5.

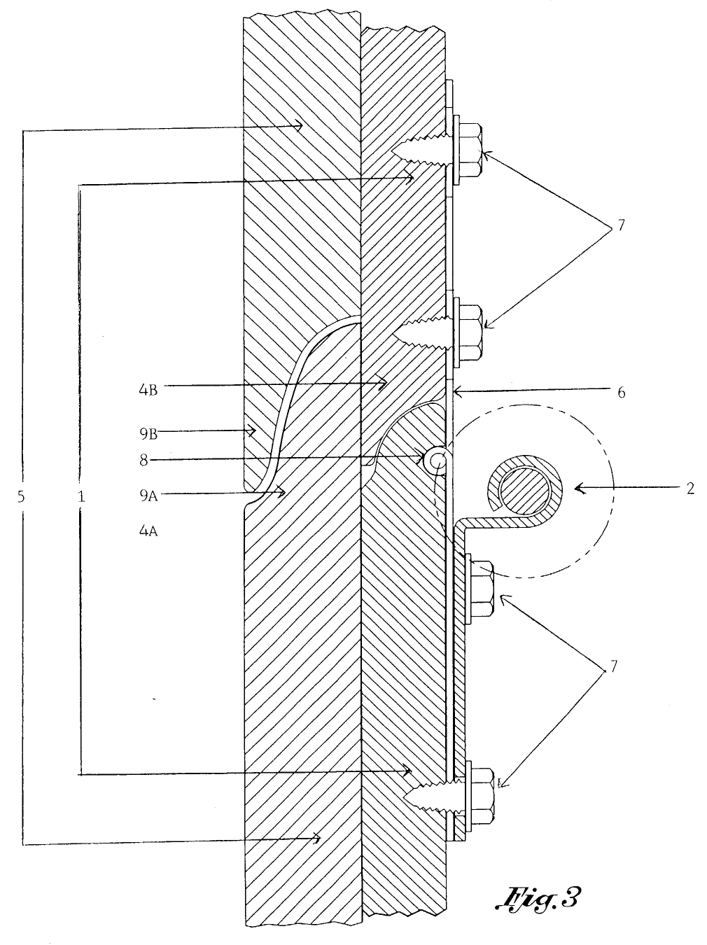

FIG. 3 shows a magnified view as marked in FIG. 2. The specially designed edge profiles for both the door panel and the trim is more easily seen in this side cutaway view. The gap between the two panels of the door and the two panels of the trim would be approximately 1 millimeter in width, and in any event no more than 1 centimeter.

The illustration in FIG. 3A presents a side cutaway view of the door when the panels have been moved at angles to each other during opening or closing. The door hinge assemblies and the guide tracks keep the motion of the door limited such that the angle between panels will always open the same way and to the same width. The gap between the panels will always be blocked from the exterior by the curved concave edge 4b of the panel.

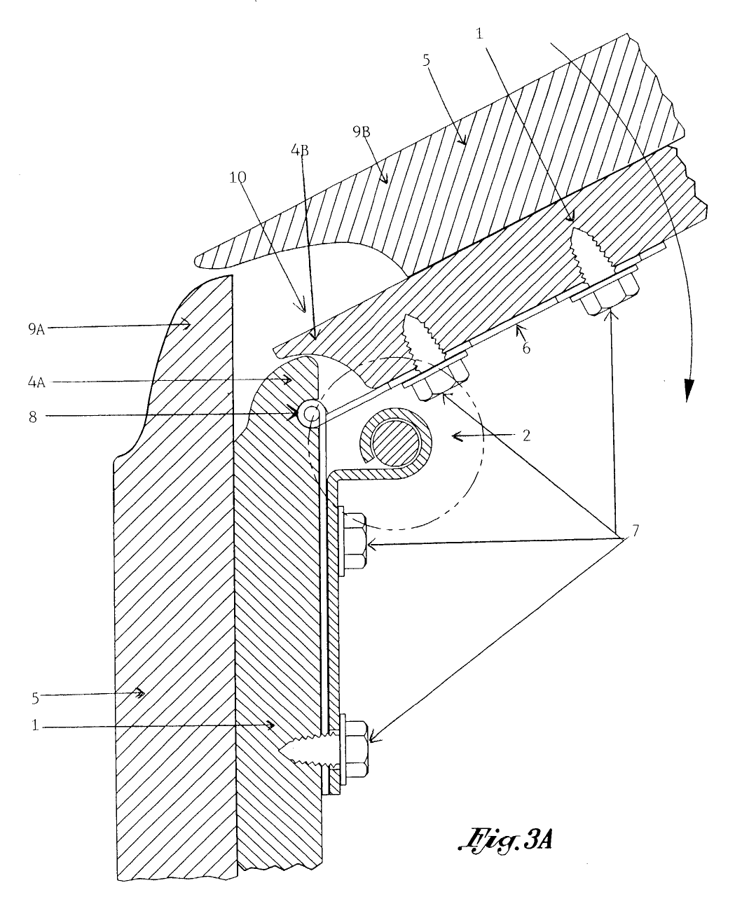

FIGS. 4 and 5 show a partial view of two adjacent panels of the sectional door from a front and rear view, respectively. In FIG. 4, the wheel and guide track at the left is shown for illustrative purposes to provide a reference point for the view shown. At the left side of the door panels a trim piece for the door can be seen. The gap between the door panels is illustrated, and it can be seen that the gap between the trim pieces is offset to allow for the wider angle of opening required for the trim as the outer layer. This offset can be 1 centimeter to 10 centimeters or more from the edge of the door panels, and in best practice is dependent on the door and trim thickness, as described in the following section.

In FIG. 5, the hinges, track, and wheel assemblies can be seen in this rear view. These assemblies are only illustrative, and the actual assemblies used can vary depending on use, weight, material, and other variables for the door. This Figure shows the small square groove 11 that is made parallel to the door panel edge along the entire length of the door to accommodate the inset hinge pin joint 8 so that the hinges can be attached in a planar fashion to the door panels. This square score is optional and completely dependent on the hinge assemblies used.

### DETAILED DESCRIPTION OF THE INVENTION

The present invention relates to an upward opening door, such as is commonly found in residential and commercial garages, warehouses, sheds, and the like. This type of door has many attributes, as previously discussed. However, one drawback is the propensity for gaps to be exposed in transitory fashion during operation of the door, ie when opening and when closing. These gaps present a potential for pinching or grabbing, resulting in personal injury or damage to property.

The present invention contemplates modified edges on each panel of said door. The edges are curved in a mating fashion, one edge convex, and the facing edge of the adjoining panel concave. When properly cut, and mated, the edges will fit closely together during opening and closing. Little if any space will be exposed to the front surface of the door.

It will be appreciated that, for a given door, all panels could be produced with convex edges at the lower end of each panel, and concave edges at the upper end of each panel.

Alternatively, all panels could be produced with concave edges at the lower end of each panel, and convex edges at the upper end of each panel. Each configuration is contemplated within the present invention, as is a third embodiment of a sectional door with alternating panels, alternating between a panel with both edges convex, and a panel with both edges concave.

The preferred shape of the curve is that of the arc of a circle. More specifically, the curve is a portion of arc of 90 degrees, or less, of the circle of radius equal to the distance from the center of the axle of the hinge to the front (top) surface of the door. As most hinges are cylindrical, with a circular cross section, the edges of the door panels describe a circular arc as the door opens and closes.

Furthermore, the hinges never have to open as far as 90 degrees, to accommodate a full door opening. This indicates the length of arc that must be cut into the edges of each panel. As long as the convex and the concave mating edges overlap at or near a 90-degree opening, the door will not present a gap on the exterior surface.

While a circular arc is the most common type of opening curve, and thus incorporated in the preferred embodiment of the current invention, other types of curves are also encompassed within the current invention, non-exclusive examples of which are oval, ovoid, spherical, elliptical, and complex curves.

Yet another embodiment of this invention is the trim facing attached to the exterior of an upwardly opening door. Such trim is commonly found on all types of garage and other exterior doors. The improvement contemplated in this invention is that the trim is coordinated with the door edges, by being similarly curved at panel edges, in order to cooperatively open and close while avoiding the exposure of gaps that could lead to pinching or catching.

In order to cooperatively open and close with the door panels, the trim must be cut in a similar but not identical curve to that cut in the door panel edges. This is demonstrated in FIG. 2, a cutaway side view of a portion of a door at rest. The guide wheels 3 are located on the underside or interior of the door. On the opposite exterior side lies the trim 5.

FIG. 3 provides an expanded view of the same cutaway side of the door. It is clear here that the trim has a somewhat more exaggerated curve 9 than the door panel edge 4. Furthermore, it is apparent that the trim curve is offset relative to the panel edge curve.

In a preferred embodiment of this invention, the curves are best described as arcs of a circle centered on the axle of the guide wheel. The door panel edge curve describes an arc of a circle of this type, with radius equal to the distance from the axle to the top of the door panel. This creates a convex panel edge 4a and a concave panel edge 4b.

The trim similarly has a curve 9 in the shape of an arc of a circle centered on the axle of the guide wheel. The radius is larger than that of the door panel edge curve by the width of the trim. Because the radius is larger, the curve sweeps over a greater linear distance. Therefore, while the curve in the trim begins (eg, the cutaway starts) directly over the same point on the top of the door panel edge, the curve does not end on the trim until a point much farther ahead than the same end point on the top of the door panel edge. This extra distance is approximately equal to the thickness of the trim, as expected from the circular model.

While the curves in both trim and door panel edge are substantially described by arcs of a circle as described above, it can be seen that the initial part of the curve deviates from a circle. This deviation is important, to accommodate a blunt nose in the concave panel. The blunt nose is more robust than a thin nose that would result from a curve completely described by a circular arc.

One more aspect of the present invention can be seen from FIG. 3A. This figure depicts the cutaway side view of an expanded panel of the door in the opened position. From this view, it can be appreciated that exterior gaps are minimized by both trim and door panels. However, a side gap is created, particularly noticeable in the trim, between convex and concave trim edges 9a and 9b.

This gap is removed by adding a thin piece of shielding material 10 to the side of the trim. This is optionally rectangular shaped, 1 millimeter thick, and sufficiently long so as to obstruct from the side the opening between the convex and concave trim edges 9a and 9b. The shield 10 is perpendicular to the door panel 1, and immediately adjacent to the side of a trim piece 5. The shield can be placed on one or both sides of the trim.

While the present invention has been described in terms of several preferred embodiments, it is not intended to limit the invention to the particular forms set forth. On the contrary, the present invention is intended to cover such alternatives, alterations, modifications, and equivalent structures and devices as may be included within the spirit and scope of the invention as defined within the appended claims.

I claim:

1. A sectional upward-opening door, wherein the edges of adjacent sections are closely fitted and shaped to avoid forming exterior-facing gaps of approximately 1 cm or greater during operation, and at rest.

2. A sectional upward-opening door according to claim 1, wherein said edges of said sections are curved, with the upper edge curved convexly, and the lower edge curved concavely, each of similar curvature in order to achieve a close fit during operation, and at rest.

3. A sectional upward-opening door, according to claim 1, wherein said sections are preferably approximately 0.5 to 2.5 inches in thickness, more preferably approximately 0.75 to 1.5 inches in thickness; and wherein said edges curve smoothly in an approximately circular arc from full thickness at a point approximately 2 inches from the edge to a smoothly rounded point at the end.

4. A sectional upward-opening door according to claim 1, wherein said door is composed of wood, metal, or plastic.

5. A sectional upward-opening door according to claim 1, suitable for use as a garage door, shed door, warehouse door, and the like.

6. Trim pieces for adornment of the exterior of a sectional upward-opening door, wherein the edges of adjacent trim sections are closely fitted to avoid gaps of 1 cm or greater, wherein said trim pieces are composed of wood, metal, or plastic and wherein the trim pieces are shaped to open in coordination with the door, continuously avoiding said gaps.

7. The trim pieces of claim 6, additionally comprised of side shields, preferably rectangular and flush with the sides of said trim pieces, and located at the edges of door panels, of a size sufficient to substantially cover and obstruct any gaps or openings formed on the side of the edges of said trim pieces during door opening and closing.

8. A sectional upward-opening door according to claim 1, additionally comprising the trim pieces of claim 6.
